(19) United States
(12) Patent Application Publication
(10) Pub. No.: US 2017/0318805 A1
(43) Pub. Date: Nov. 9, 2017

(54) METHOD OF PREPARING AN AGROCHEMICAL COMPOSITION WITH REDUCED TOXICITY BY MILLING A PREMIX OF A PESTICIDE AND A HYDROPHOBIN

(71) Applicant: BASF SE, Ludwigshafen (DE)

(72) Inventors: Winfried MAYER, Bubenheim (DE); Steffen KUHN, Schifferstadt (DE); Thomas OTTILLINGER, Schifferstadt (DE); Elke WITTMER, Deidesheim (DE); Thomas SUBKOWSKI, Schriesheim (DE)

(21) Appl. No.: 15/523,844

(22) PCT Filed: Oct. 26, 2015
(86) PCT No.: PCT/EP2015/074716

§ 371 Date: May 2, 2017

(30) Foreign Application Priority Data
Nov. 5, 2014 (EP) 14191919.1

(51) Int. Cl. A01N 25/32; A01N 25/04; A01N 37/34; A01N 43/56

(52) U.S. Cl. CPC A01N 25/32; A01N 43/56; A01N 25/04; A01N 37/34

(57) ABSTRACT

The invention relates to a method of preparing an agrochemical composition comprising the steps of preparing a premix by contacting a solid water-insoluble pesticide and a hydrophobin and preparing a raw suspension by milling the premix; an agrochemical composition which is obtainable by said method; a use and method of application of hydrophobin for reducing the toxicity of a solid water-insoluble pesticide; a method of controlling phytopathogenic fungi and/or undesired plant growth and/or undesired insect or mite attack and/or for regulating the growth of plants; and seed containing said suspension.

The present invention relates to a method of preparing an agrochemical composition comprising the steps of preparing a premix by contacting a solid water-insoluble pesticide and a hydrophobin and preparing a raw suspension by milling the premix. Furthermore, the invention relates to an agrochemical composition comprising a solid water-insoluble pesticide and a hydrophobin, where the composition is obtainable by said method. Moreover, the invention is directed towards the use of hydrophobin for reducing the toxicity of a solid water-insoluble pesticide. Further subject matter are a method of controlling phytopathogenic fungi and/or undesired plant growth and/or undesired insect or mite attack and/or for regulating the growth of plants, wherein the composition is allowed to act on the respective pests, their environment or the crop plants to be protected from the respective pest, on the soil and/or on undesired plants and/or on the crop plants and/or on their environment; a method for reducing the toxicity of a solid water-insoluble pesticide comprising the step of contacting the water-insoluble pesticide with hydrophobin; and seed containing said suspension.

Various methods were developed to reduce toxicity of pesticides, e.g. for farmers handling the agrochemical compositions. It is recommended to reduce the exposure time, use safety gloves or safety glasses. The concentration of a pesticide in a formulation may be reduced, or pesticides may be encapsulated in poly(meth)acrylates or polyurea capsules.

Object of the present invention was to find a method of reducing the toxicity of pesticides in agrochemical compositions.

The object was achieved by a method of preparing an agrochemical composition comprising the steps of

a) preparing a premix by contacting a solid water-insoluble pesticide and a hydrophobin, and

b) preparing a raw suspension by milling the premix.

The present application also comprises within its scope combinations of embodiments, combinations of preferred embodiments, and combinations of preferred forms, each irrespective of the degree of preference.

In step a) the contacting may be done by mixing (e.g. by stirring, shaking, pouring) the pesticide, the hydrophobin, and optionally the water and the dispersing agent. The components in step a) may be mixed in any order. Usually, the hydrophobin is added last and just after the pesticides. The contacting in step a) may be done at a temperature of −20 to 100° C., preferably at 5 to 80° C., and in particular at 10 to 50° C.

Preferably, step a) comprises preparing the premix by contacting the pesticide, the hydrophobin, and water.

In another preferred form step a) comprises preparing the premix by contacting the pesticide, the hydrophobin, and a dispersing agent.

More preferably step a) comprises preparing the premix by contacting the pesticide, the hydrophobin, water, and the dispersing agent.

The premix or the raw suspension may comprise at least 100 g/l, preferably at least 200 g/l, more preferably at least 300 g/l of the pesticide. The premix may comprise up to 999 g/l, preferably up to 950 g/l, and in particular up to 900 g/l of the pesticide.

The premix or the raw suspension may comprise at least 0.1 g/l, preferably at least 0.5 g/l of the hydrophobin. The premix may comprise up to 50 g/l, preferably up to 20 g/l, and in particular up to 10 g/l of the hydrophobin.

The premix or the raw suspension may comprise at least 10 wt %, preferably at least 20 wt %, and in particular at least 30 wt % of the water. The premix may comprise up to 90 wt %, preferably up to 70 wt %, and in particular up to 60 wt % of the water.

The premix or the raw suspension may comprise at least 1 g/l, preferably at least 5 g/l, and in particular at least 10 g/l of the dispersing agent. The premix may comprise up to 250 g/l, preferably up to 100 g/l, and in particular up to 50 g/l of the dispersing agent.

In a preferred embodiment, the premix contains at least 100 g/l of at least one pesticide, at least 1 g/l of the hydrophobin, at least 20% of the water and at least 5 g/l of the dispersing agent.

In a more preferred embodiment, the premix contains at least 300 g/l of at least one pesticide, at least 1 g/l of the hydrophobin, at least 20% of the water and at least 5 g/l of the dispersing agent.

Also in a preferred embodiment, the premix contains up to 900 g/l of at least one pesticide, up to 20 g/l of the hydrophobin, up to 90 wt % of the water and up to 100 g/l of the dispersing agent.

Also in a more preferred embodiment, the premix contains up to 900 g/l of at least one pesticide, up to 20 g/l of the hydrophobin, up to 90 wt % of the water and up to 50 g/l of the dispersing agent.

In step b) the milling may be done in typical milling devices, such as ball mills, bead mills, rod mills, semi- and autogenous mills, pebble mills, grinding roll mills, Buhrstone mills, tower mills, hammer mills, planetary mills, vertical-shaft-impactor mills, colloid mills, cone mills, disk mills, edge mills, jet mills, pellet mills, stirred mills, three roll mills, vibratory mills, Wiley mills or similar milling and grinding devices known by the skilled person.

The pesticide may be present in form of particles in the premix. The particle size of the pesticide in the premix may be bigger than 100 μm, preferably bigger than 50 μm, most preferably from 50 to 100 μm.

The pesticide may be present in form of particles in the raw suspension. The particle size of the pesticide in the raw suspension may be smaller than 100 μm, preferably smaller than 50 μm, more preferably smaller than 10 μm and especially preferably smaller than 5 μm. In particular, the particle size of the pesticide is smaller than 3 μm. Herein, the pesticide particles usually have a particle size distribution and the values given above refer to the stochastic d₅₀ value, which is a typical characterization unit known to the skilled person.

The particle size distribution can be determined by laser light diffraction of an aqueous suspension comprising the particles. The sample preparation, for example the dilution to the measuring concentration, will, in this measuring method, depend on the fineness and concentration of the active substances in the suspension sample and on the apparatus used (for example Malvern Mastersizer), inter alia. The procedure should be developed for the system in question and is known to a person skilled in the art.

The term pesticide refers to at least one active substance selected from the group of the fungicides, insecticides, nematicides, herbicides, safeners, biopesticides and/or growth regulators. Preferred pesticides are fungicides, insecticides, herbicides and growth regulators. Especially preferred pesticides are insecticides. Mixtures of pesticides of two or more of the abovementioned classes may also be used. The skilled worker is familiar with such pesticides, which can be found, for example, in the Pesticide Manual, 16th Ed. (2013), The British Crop Protection Council, London. Suitable insecticides are insecticides from the class of the carbamates, organophosphates, organochlorine insecticides, phenylpyrazoles, pyrethroids, neonicotinoids, spinosins, avermectins, milbemycins, juvenile hormone analogs, alkyl halides, organotin compounds nereistoxin analogs, benzoylureas, diacylhydrazines, M ETI acarizides, and insecticides such as chloropicrin, pymetrozin, flonicamid, clofentezin, hexythiazox, etoxazole, diafenthiuron, propargite, tetradifon, chlorofenapyr, DNOC, buprofezine, cyromazine, amitraz, hydramethylnon, acequinocyl, fluacrypyrim, rotenone, or their derivatives. Suitable fungicides are fungicides from the classes of dinitroanilines, allylamines, anilinopyrimidines, antibiotics, aromatic hydrocarbons, benzenesulfonamides, benzimidazoles, benzisothiazoles, benzophenones, benzothiadiazoles, benzotriazines, benzyl carbamates, carbamates, carboxamides, carboxylic acid diamides, chloronitriles cyanoacetamide oximes, cyanoimidazoles, cyclopropanecarboxamides, dicarboximides, dihydrodioxazines, dinitrophenyl crotonates, dithiocarbamates, dithiolanes, ethylphosphonates, ethylaminothiazolecarboxamides, guanidines, hydroxy-(2-amino)pyrimidines, hydroxyanilides, imidazoles, imidazolinones, inorganic substances, isobenzofuranones, methoxyacrylates, methoxycarbamates, morpholines, N-phenylcarbamates, oxazolidinediones, oximinoacetates, oximinoacetamides, peptidylpyrimidine nucleosides, phenylacetamides, phenylamides, phenylpyrroles, phenylureas, phosphonates, phosphorothiolates, phthalamic acids, phthalimides, piperazines, piperidines, propionamides, pyridazinones, pyridines, pyridinylmethylbenzamides, pyrimidinamines, pyrimidines, pyrimidinonehydrazones, pyrroloquinolinones, quinazolinones, quinolines, quinones, sulfamides, sulfamoyltriazoles, thiazolecarboxamides, thiocarbamates, thiophanates, thiophenecarboxamides, toluamides, triphenyltin compounds, triazines, triazoles. Suitable herbicides are herbicides from the classes of the acetamides, amides, aryloxyphenoxypropionates, benzamides, benzofuran, benzoic acids, benzothiadiazinones, bipyridylium, carbamates, chloroacetamides, chlorocarboxylic acids, cyclohexanediones, dinitroanilines, dinitrophenol, diphenyl ether, glycines, imidazolinones, isoxazoles, isoxazolidinones, nitriles, N-phenylphthalimides, oxadiazoles, oxazolidinediones, oxyacetamides, phenoxycarboxylic acids, phenylcarbamates, phenylpyrazoles, phenylpyrazolines, phenylpyridazines, phosphinic acids, phosphoroamidates, phosphorodithioates, phthalamates, pyrazoles, pyridazinones, pyridines, pyridinecarboxylic acids, pyridinecarboxamides, pyrimidinediones, pyrimidinyl(thio)benzoates, quinolinecarboxylic acids, semicarbazones, sulfonylaminocarbonyltriazolinones, sulfonylureas, tetrazolinones, thiadiazoles, thiocarbamates, triazines, triazinones, triazoles, triazolinones, triazolocarboxamides, triazolopyrimidines, triketones, uracils, ureas.

Preferably, the pesticide is selected from fungicides, more preferably from fungicides that carry halogen atoms. Especially preferably, the pesticide is selected from chlorothalonil and fluxapyroxad. In one embodiment, the pesticide is chlorothalonil. In another embodiment, the pesticide is fluxapyroxad.

The pesticide may comprise at least one water-insoluble pesticide. Water-insoluble pesticides may have solubility in water of up to 10 g/l, preferably up to 1 g/l, and in particular up to 0.5 g/l, at 20° C.

The pesticide, such as the water-insoluble pesticide, usually has a melting point of above 30° C., preferably above 50° C. and specifically above 70° C.

Suitable pesticides are usually polyhalogenated pesticides.

The pesticide usually carries at least 2 covalently-linked halogen atoms, preferably chlorine or fluorine, more preferably chlorine.

Preferably, the pesticide carries at least 3 covalently-linked halogen atoms, preferably chlorine or fluorine, more preferably chlorine.

More preferably, the pesticide carries at least 4 covalently-linked halogen atoms, preferably chlorine or fluorine, more preferably chlorine.

Hydrophobins according to the invention can be described by the general formula (I)

Xₙ—C¹—X₁₋₅₀—C²—X₀₋₅—C³—X₁₋₁₀₀—C⁴—X₁₋₁₀₀—C⁵—X₁₋₅₀—C⁶—X₀₋₅—C⁷—X₁₋₅₀—C⁸—Xₘ (I)

wherein X stands for any of the 20 naturally occuring amino acids (Phe, Leu, Ser, Tyr, Cys, Trp, Pro, His, Gln, Arg, Ile Met, Thr, Asn, Lys, Val, Ala, Asp, Glu, Gly) and wherein the assigned indexes stand for the number of amino acids. Herein, the indexes n and m stand for numbers from 0 to 500, preferably from 15 to 300, C stands for Cystein and at least one of the polypeptide sequences Xₘ or Xₙ stands for a peptide sequence of at least 20 amino acids, which is not naturally connected to a hydrophobin. Herein, the hydrophobin causes a shift of the contact angle after coating of a glass surface of at least 20°.

The Cysteins C¹ to C⁸ according to the invention can be present either in reduced or oxidized form or build up disulfide bridges. Especially preferred is the intramolecular formation of disulfide bridges, in particular those with one, preferably two, more preferably 3 and especially preferred 4 intramolecular disulfide bridges selected from the following group: C¹ with C²; C³ with C⁴; C⁵ with C⁶; C⁷ with C⁸.

In case that Cys is used in the positions X, the assigned numbers of the different Cystein-positions in the general formulae change accordingly.

Preferred polypeptides are those of the general formula (II)

Xₙ—C¹—X₃₋₂₅—C²—X₀₋₂—C³—X₅₋₅₀—C⁴—X₂₋₃₅—C⁵—X₂₋₁₅—C⁶—X₀₋₂—C⁷—X₃₋₃₅—C⁸—Xₘ (II)

wherein X stands for any of the 20 naturally occuring amino acids (Phe, Leu, Ser, Tyr, Cys, Trp, Pro, His, Gln, Arg, Ile Met, Thr, Asn, Lys, Val, Ala, Asp, Glu, Gly) and wherein the assigned indexes stand for the number of amino acids. Herein, the indexes n and m stand for numbers from 2 to 300, C stands for Cystein and at least one of the polypeptide sequences Xₘ or Xₙ stands for a peptide sequence of at least 35 amino acids, which is not naturally connected to a hydrophobin. Herein, the hydrophobin causes a shift of the contact angle after coating of a glass surface of at least 20°.

Especially preferred polypeptides are those of the general formula (III)

Xₙ—C¹—X₅₋₉—C²—C³—X₁₁₋₃₉—C⁴—X₂₋₂₃—C⁵—X₅₋₉—C⁶—C⁷—X₆₋₁₈—C⁸—Xₘ (III)

wherein X stands for any of the 20 naturally occuring amino acids (Phe, Leu, Ser, Tyr, Cys, Trp, Pro, His, Gln, Arg, Ile Met, Thr, Asn, Lys, Val, Ala, Asp, Glu, Gly) and wherein the assigned indexes stand for the number of amino acids. Herein, the indexes n and m stand for numbers from 0 to 200, C stands for Cystein and at least one of the polypeptide sequences Xₘ or Xₙ stands for a peptide sequence of at least 40 amino acids, which is not naturally connected to a hydrophobin. Herein the hydrophobin causes a shift of the contact angle after coating of a glass surface of at least 20°.

Particularly preferred are polypeptides formulae (I), (II) or (III), wherein the respective formula comprises at least one hydrophobin selected from dewA, rodA, hypA, hypB, sc3, basf1, basf2 and parts and derivatives thereof; preferably of dewA, rodA, basf1, basf2, and derivatives thereof; most preferably from dewA, rodA, and derivatives thereof. In one embodiment, the hydrophobin is dewA, or a derivative thereof. In another embodiment, the hydrophobin is rodA, or a derivative thereof. In another embodiment, the hydrophobin is hypA, or a derivative thereof. In another embodiment, the hydrophobin is hypB, or a derivative thereof. In another embodiment, the hydrophobin is sc3, or a derivative thereof. In another embodiment, the hydrophobin is basf1, or a derivative thereof. In another embodiment, the hydrophobin is basf2, or a derivative thereof. The sequences of said hydrophobins are disclosed in WO 2006/082251, SEQ ID NO 1-14.

The proteins according to the present invention carry at least at one position Xn or Xm a polymer sequence of at least 20, preferably 35, especially preferred 50 and in particular 100 amino acids (called fusion partner in the following), which is not naturally linked to a hydrophobin. Thereby it shall be pronounced that the proteins are composed of a hydrophobin part and a fusion partner and do not occur as such in nature.

The fusion partner moiety can be selected from a variety of proteins. Also several fusion partners may be linked to a hydrophobin, e.g. at the amino terminus (Xn) and at the carboxy terminus (Xm) of the hydrophobin moiety. It is also possible that two fusion partners are linked to one position (Xn or Xm) of the protein according to the invention.

Preferred fusion partners are polypeptides, which occur naturally in microorganisms, in particular in E. coli, or Bacillus subtilis. Examples for such fusion partners are the sequences yaad, yaae and thioredoxin, which are disclosed in WO 2006/082251, SEQ ID NO 15-18. In one embodiment, the fusion partner is yaad. In another embodiment, the fusion partner is yaae. In another embodiment, the fusion partner is thiaredoxin.

Suitable fusion partners are also fragments or derivatives of said sequences, which comprise only a part, preferably 70 to 99%, more preferably 80 to 98% of these sequences, or sequences in which single amino acids or nucleotides are altered. Examples would be further amino acids at the C-terminus of the sequences yaad and yaae, in particular two amino acids, preferably the amino acids Arg and Ser. Also, further amino acids may be inserted into the sequence of yaae, e.g. the amino acid No 2 (Gly) according to WO 2006/131564, SEQ ID NO 17-18.

The preparation of hydrophobins can be achieved by chemical processes of peptide synthesis, e.g. by solid phase synthesis, which are known to a person skilled in the art.

Especially preferred, however, are processes involving genetically modified organisms or cell lines as production systems, wherein the gene sequences coding for the fusion partner and for the hydrophobin part are combined in an expression construct. The desired protein is then produced in the production system after the transfer of the expression construct into said production system as the gene expression product of the combined gene sequences.

Suitable gene expression constructs are known in literature (e.g. WO 2006/082251) and are easily devised by a person skilled in the art. The corresponding polypeptide construct may carry additional amino acids at both termini as a result of the genetic construct, as well as additional amino acids between the fusion protein and the hydrophobin.

Possible modifications of the hydrophobin molecules may involve glycosylation, acetylation, or chemical crosslinking, e.g. with glutaraldehyde.

One feature of the hydrophobins according to the invention is the alteration of surface characteristics, if these surfaces are coated with the proteins. This alteration can be experimentally determined by measuring the contact angle of a water droplet before and after coating of the surface with the protein and calculating the difference between both values.

The experimental conditions for the measurement of the contact angle are described by the following procedure:

The coating properties of hydrophobin or hydrophobin-fusion proteins are measured preferably on glass or Teflon as models for hydrophobic and hydrophilic surfaces.

If they are carried out on glass, the glass platelet is incubated in a solution of 1-100 μg/ml hydrophobin in 50 mM Na-acetate pH 4 and 0.1% Tween 20 at 80° C. over night, then rinsed with H₂0_{dd}, incubated in 1% SDS for 10 minutes at 80° C. and washed with H₂0_{dd}.

If they are carried out on Teflon, the Teflon platelet is incubated in a solution of 1-100 μg/ml hydrophobin in 10 mM Tris pH 8 at 80° C. over night, then rinsed with H₂0_{dd}, incubated in 1% SDS for 10 minutes at 80° C. and washed with H₂0_{dd}.

The samples are then air-dried and the contact angle of a droplet of 5 μl water is measured on a Dataphysics Contact Angle System OCA 15+, Software SCA 20.2.0 (November 2002). The measurement was performed due to the manufacturer's instructions.

Under these conditions, the proteins of the present invention increase the contact angle for at least 20, preferably 25 and especially 30 degrees.

Suitable production systems can be prokaryots (including archaea) or eukaryots, preferably bacteria including halobacteria and methanococcae, fungi, insect cells, plant cells, mammalian cells, especially preferred Escherichia coli, Bacillus subtilis, Bacillus megaterium, Aspergillus oryzea, Aspergillus nidulans, Aspergillus niger, Pichia pastoris, Pseudomonas spec., Lactobacillus, Hansenula polymorpha, Trichoderma reesei or SF9 cells (and similar cell lines).

Preferred production systems are genetically modified organisms or cell lines, preferably Escherichia coli, Bacillus subtilis and SF9 cells and especially preferably Escherichia coli.

Depending on the production system used according to the invention, they are grown or cultivated in a way known to the skilled person. Microorganisms are usually grown in liquid medium containing a carbon source, usually in form of sugars, a nitrogen source usually in form of organic nitrogen sources such as yeast extract or salts, such as ammonium sulfate, trace elements, such as iron-, manganese-, magnesium salts and optionally vitamins. They are usually grown at temperatures between 0 and 100° C., preferably between 10 and 60° C., under supplementary oxygen gassing. Herein, the pH of the nutrition solution can be kept at a distinct value, i.e. it can be regulated during fermentation or not. The fermentation can be carried out as a batch process, as a semi-batch process or continuously. Nutrition material can be supplied at the beginning of the fermentation; it can be added semi-continuously or continuously. The proteins can be isolated from the organisms or used as crude extract for the described purpose according to the invention.

The production of the hydrophobins can be achieved by cultivating a polypeptide-producing microorganism, optionally inducing the expression of the polypeptides and isolating the protein from liquid culture.

The genetically modified organism or cell line can be cultivated and fermented. Bacteria can be grown, for example, in TB- or LB-medium or at a temperature ranging from 20 to 40° C. and a pH from 6 to 9. Suitable culturing conditions can be found in T. Maniatis, E. F. Fritsch and J. Sambrook, Molecular Cloning : A Laboratory Manual, Cold Spring Harbor Laboratory, Cold Spring Harbor, N.Y. (1989).

If the polypeptides are not secreted into the culture medium, the cells are then disrupted and the product is isolated from the lysate by methods known by the skilled person. The cells may be disrupted by high-frequency ultrasound, by high pressure, e.g. in a French-Press, by Osmolysis, by application of detergents, lysing enzymes or organic solvents, by homogenization or by a combination of the above listed methods. Hereby, it does not matter whether the protein occurs in a native form or as inclusion bodies. The target protein is released from the cells among other soluble proteins.

A purification of the polypeptides can be achieved by methods known to the skilled person. In a first step, the product can be separated from the cell debris for example by sedimentation in a centrifuge, by filtration or by fractionated sedimentation. This works especially well if the target protein occurs as inclusion bodies. In this case, they can be separated from the cell debris by centrifugal separation in a separator or a nozzle separator selectively. After renaturing of the protein (e.g. by methods described in WO 2008/019964) the purification of the protein can be achieved by known chromatographic methods, for example by gel filtration, ion-exchange chromatography and hydrophobic-interaction chromatography, as well as with all other common methods such as ultrafiltration, crystallization, salting out, dialysis or native gel electrophoresis. Suitable methods are described in Cooper, F. G., Biochemische Arbeitsmethoden, Verlag Water de Gruyter, Berlin, New York or in Scopes, R., Protein Purification, Springer Verlag, New York, Heidelberg, Berlin.

Afterwards, a formulation of the protein can be prepared by drying the protein solution, e.g. by freeze drying, spray drying, spray granulation or water evaporation, and using the protein as dust or granulate.

As an example, spray drying and spray granulation can be achieved as described in WO 2008/019964.

It may be advantageous to use vector systems or oligonucleotides for the isolation of the recombinant protein, which extend the cDNA for certain nucleotide sequences coding for altered polypeptides of fusion proteins, which facilitate the isolation. Suitable modifications are, for example, so-called tags, such as the hexa-histidin tag (His₆) or epitopes, which can be recognized as antigens by antibodies (described in Harlow, E. and Lane, D., 1988, Antibodies: A Laboratory Manual. Cold Spring Harbor (N. Y.) Press).

Further suitable tags are, for example HA-tags, calmodulin-BD, GST, MBD, chitin-BD, Streptavidin-BD-Avi-tag, Flag-tag, T7, etc. These tags may be used for anchoring the proteins to a solid surface, e.g. a polymer matrix, which may be incorporated into a chromatography column, or to a microtiter plate or to any other surface. The corresponding purification protocols are available from the commercial affinity-tag-providers.

In one embodiment the tag is a His₆ tag. In another embodiment, the tag is a HA-tag. In yet another embodiment, the tag is a calmodulin-BD tag. In another embodiment, the tag is a GST-tag. In another embodiment, the tag is a MBD-tag. In another embodiment, the tag is a chitin-BD-tag. In another embodiment, the tag is a Streptavidin-BD-Avi-tag. In another embodiment, the tag is a Flag-tag.

The hydrophobin proteins according to the invention have the features desired from hydrophobins both in their form as a fusion protein and in their isolated form. They can thus be applied directly or after the cleavage and separation of the fusion partner as “pure” hydrophobins.

If a separation of the fusion partner is intended, a suitable cleavage site (specific recognition site for proteases) is introduced into the fusion protein between the hydrophobin protein and the fusion partner. Suitable cleavage sites are preferably those, which occur neither in the hydrophobin moiety nor in the fusion protein part, which can be easily ascertained by bioinformatic tools. Especially suitable are, for example BrCN cleavages at methionine, or protease mediated cleavage by factor Xa-, Enterokinase-, Thrombin, TEV-cleavage (Tobacco etch virus protease).

The present invention further relates to an agrochemical composition comprising the solid water-insoluble pesticide and the hydrophobin, where the composition is obtainable (preferably is obtained) by the method according to the invention. In one form the agrochemical composition comprising the pesticide and the hydrophobin is obtainable by the method comprising the steps of a) preparing the premix by contacting the pesticide and the hydrophobin, and b) preparing the raw suspension by milling the premix.

The agrochemical composition may be present in various formulation types, such as suspensions (e.g. SC, OD, FS, ZC), wettable powders or dusts (e.g. WP, SP, WS, DP, DS), granules (e.g. WG, SG, GR, FG, GG, MG). These and further compositions types are defined in the “Catalogue of pesticide formulation types and international coding system”, Technical Monograph No. 2, 6th Ed. May 2008, CropLife International.

In one form the agrochemical composition is an aqueous suspension. The suspension comprises the pesticide in form of pesticide particles, which are usually suspended in a continuous aqueous phase. The pesticide particles may be present in the form of crystalline or amorphous particles which are solid at 20° C.

The agrochemical composition in form of a suspension concentrate may comprise from 0.1 g/l to 50 g/l of the hydrophobin, preferably from 0.1 g/l to 10 g/l, more preferably from 0.5 to 10 g/l of the hydrophobin, and in particular 1 to 10 g/l of the hydrophobin.

In one form of the invention, the agrochemical composition in form of a suspension may comprise at least 100 g/l of the pesticide, from 0.1 to 10 g/l of the hydrophobin, and at least 1 g/l of a dispersing agent.

Preferably, the agrochemical composition in form of a suspension concentrate may comprise at least 100 g/l of the pesticide, from 0.5 to 10 g/l of the hydrophobin, and at least 5 g/l of a dispersing agent.

More preferably, the agrochemical composition in form of a suspension concentrate may comprise at least 200 g/l of the pesticide, from 0.5 to 5 g/l of the hydrophobin, and at least 10 g/l of a dispersing agent.

The agrochemical composition in form of a suspension concentrate may comprise up to 900 g/l of the pesticide, up to 10 g/l of the hydrophobin, and up to 100 g/l of a dispersing agent.

Preferably, the agrochemical composition in form of a suspension concentrate may comprise up to 900 g/l of the pesticide, up to 10 g/l of the hydrophobin, and up to 50 g/l of a dispersing agent.

The suspension may comprise a further pesticide in addition to the pesticides in form of pesticide particles, where the further pesticide is dissolved in the aqueous phase of the suspension.

The agrochemical composition is preferably an aqueous suspension, which means the suspension comprises water. The suspension can comprise at least 15% by weight, preferably at least 30% by weight and especially preferably at least 40% by weight of water based on the total weight of the suspension. The suspension can comprise from 20 to 85% by weight, preferably from 30 to 75% by weight and especially preferably from 35 to 70% by weight of water, based on the total weight of the suspension.

In another form the agrochemical composition is a solid formulation type, such as a wettable powder or dust (e.g. WP, SP, WS, DP, DS), or a granule (e.g. WG, SG, GR, FG, GG, MG). The solid formulation types may be prepared by the method according to the invention which comprises in addition to the steps a) and b) a step c) which is drying the raw suspension. The drying may be achieved by conventional means, e.g. by evaporating any liquids, such as water, by applying elevated temperatures and/or vacuum.

In another form the agrochemical composition is a solid formulation type selected from water-dispersible granules or a water-soluble granule, which may comprise 50-80 wt % of the pesticide and up to 100 wt % dispersants and wetting agents (e.g. sodium lignosulfonate and alcohol ethoxylate).

In another form the agrochemical composition is a solid formulation type selected from water-dispersible powders and water-soluble powders, which may comprise 50-80 wt % of the pesticide, 1-5 wt % dispersants (e.g. sodium lignosulfonate), 1-3 wt % wetting agents (e.g. alcohol ethoxylate) and up to 100 wt % solid carrier, e.g. silica gel.

The agrochemical composition may comprise auxiliaries for agrochemical formulations. Examples for suitable auxiliaries are solid carriers or fillers, surfactants, dispersing agents, emulsifiers, wetters, adjuvants, solubilizers, penetration enhancers, protective colloids, adhesion agents, thickeners, humectants, repellents, attractants, feeding stimulants, compatibilizers, bactericides, anti-freezing agents, anti-foaming agents, colorants, tackifiers and binders.

Suitable solid carriers or fillers are mineral earths, e.g. silicates, silica gels, talc, kaolins, lime-stone, lime, chalk, clays, dolomite, diatomaceous earth, bentonite, calcium sulfate, magnesium sulfate, magnesium oxide; polysaccharide powders, e.g. cellulose, starch; fertilizers, e.g. ammonium sulfate, ammonium phosphate, ammonium nitrate, ureas; products of vegetable origin, e.g. cereal meal, tree bark meal, wood meal, nutshell meal, and mixtures thereof.

Suitable dispersing agents are surface-active compounds, such as anionic, cationic, nonionic and amphoteric surfactants, block polymers, polyelectrolytes, and mixtures thereof. Such surfactants can be used as emulsifier, solubilizer, wetter, penetration enhancer, protective colloid, or adjuvant. Examples of surfactants are listed in McCutcheon's, Vol. 1: Emulsifiers & Detergents, McCutcheon's Directories, Glen Rock, USA, 2008 (International Ed. or North American Ed.)

Suitable anionic surfactants are alkali, alkaline earth or ammonium salts of sulfonates, sulfates, phosphates, carboxylates, and mixtures thereof. Examples of sulfonates are alkylarylsulfonates, diphenylsulfonates, alpha-olefin sulfonates, lignine sulfonates, sulfonates of fatty acids and oils, sulfonates of ethoxylated alkylphenols, sulfonates of alkoxylated arylphenols, sulfonates of condensed naphthalenes, sulfonates of dodecyl- and tridecylbenzenes, sulfonates of naphthalenes and alkylnaphthalenes, sulfosuccinates or sulfosuccinamates. Examples of sulfates are sulfates of fatty acids and oils, of ethoxylated alkylphenols, of alcohols, of ethoxylated alcohols, or of fatty acid esters. Examples of phosphates are phosphate esters. Examples of carboxylates are alkyl carboxylates, and carboxylated alcohol or alkylphenol ethoxylates.

The suspension preferably comprises an anionic surfactant. Preferred anionic surfactants are sulfonates, where sulfonates of condensed naphthalenes are more preferred. The suspension may comprise from 0.1 to 12 wt %, preferably from 0.5 to 7 wt %, and in particular from 1 to 4 wt % of the anionic surfactant (e.g. the sulfonate).

Suitable nonionic surfactants are alkoxylates, N-subsituted fatty acid amides, amine oxides, esters, sugar-based surfactants, polymeric surfactants, and mixtures thereof. Examples of alkoxylates are compounds such as alcohols, alkylphenols, amines, amides, arylphenols, fatty acids or fatty acid esters which have been alkoxylated with 1 to 50 equivalents. Ethylene oxide and/or propylene oxide may be employed for the alkoxylation, preferably ethylene oxide. Examples of N-subsititued fatty acid amides are fatty acid glucamides or fatty acid alkanolamides. Examples of esters are fatty acid esters, glycerol esters or monoglycerides. Examples of sugar-based surfactants are sorbitans, ethoxylated sorbitans, sucrose and glucose esters or alkylpolyglucosides. Examples of polymeric surfactants are home- or copolymers of vinylpyrrolidone, vinylalcohols, or vinylacetate.

Suitable cationic surfactants are quaternary surfactants, for example quaternary ammonium compounds with one or two hydrophobic groups, or salts of long-chain primary amines. Suitable amphoteric surfactants are alkylbetains and imidazolines. Suitable block polymers are block polymers of the A-B or A-B-A type comprising blocks of polyethylene oxide and polypropylene oxide, or of the A-B-C type comprising alkanol, polyethylene oxide and polypropylene oxide. Suitable adjuvants are compounds, which have a negligible or even no pesticidal activity themselves, and which improve the biological performance of the compound I on the target. Examples are surfactants, mineral or vegetable oils, and other auxiliaries. Further examples are listed by Knowles, Adjuvants and additives, Agrow Reports DS256, T&F Informa UK, 2006, chapter 5. Suitable thickeners are polysaccharides (e.g. xanthan gum, carboxymethylcellulose), inorganic clays (organically modified or unmodified), polycarboxylates, and silicates.

Suitable bactericides are bronopol and isothiazolinone derivatives such as alkylisothiazolinones and benzisothiazolinones.

Suitable anti-freezing agents are ethylene glycol, propylene glycol, urea and glycerin.

Suitable anti-foaming agents are silicones, long chain alcohols, and salts of fatty acids.

Suitable colorants (e.g. in red, blue, or green) are pigments of low water solubility and water-soluble dyes. Examples are inorganic colorants (e.g. iron oxide, titan oxide, iron hexacyanoferrate) and organic colorants (e.g. alizarin-, azo- and phthalocyanine colorants).

Suitable tackifiers or binders are polyvinylpyrrolidons, polyvinylacetates, polyvinyl alcohols, polyacrylates, biological or synthetic waxes, and cellulose ethers.

The agrochemical composition may be employed for the purposes of treatment of plant propagation materials, particularly seeds. The compositions in question give, after two-to-tenfold dilution, active substance concentrations of from 0.01 to 60% by weight, preferably from 0.1 to 40% by weight, in the ready-to-use preparations. Application can be carried out before or during sowing.

Methods for applying or treating the agrochemical composition on to plant propagation material, especially seeds include dressing, coating, pelleting, dusting, soaking and in-furrow application methods of the propagation material. Preferably, the agrochemical composition is applied on to the plant propagation material by a method such that germination is not induced, e.g. by seed dressing, pelleting, coating and dusting.

When employed in plant protection, the amounts of active substances applied are, depending on the kind of effect desired, from 0.001 to 2 kg per ha, preferably from 0.005 to 2 kg per ha, more preferably from 0.05 to 0.9 kg per ha, in particular from 0.1 to 0.75 kg per ha. In treatment of plant propagation materials such as seeds, e. g. by dusting, coating or drenching seed, amounts of active substance of from 0.1 to 1000 g, preferably from 1 to 1000 g, more preferably from 1 to 100 g and most preferably from 5 to 100 g, per 100 kilogram of plant propagation material (preferably seed) are generally required. When used in the protection of materials or stored products, the amount of active substance applied depends on the kind of application area and on the desired effect. Amounts customarily applied in the protection of materials are 0.001 g to 2 kg, preferably 0.005 g to 1 kg, of active substance per cubic meter of treated material.

Various types of oils, wetters, adjuvants, fertilizer, or micronutrients, and other pesticides (e.g. herbicides, insecticides, fungicides, growth regulators, safeners) may be added to the suspension as premix or, if appropriate not until immediately prior to use (tank mix). These agents can be admixed with the suspensions according to the invention in a weight ratio of 1:100 to 100:1, preferably 1:10 to 10:1.

The user applies the agrochemical composition or the tank mix prepared from the agrochemical composition usually from a predosage device, a knapsack sprayer, a spray tank, a spray plane, or an irrigation system. Usually, the agrochemical composition is made up with water, buffer, and/or further auxiliaries to the desired application concentration and the ready-to-use spray liquor or the agrochemical composition is thus obtained. Usually, 20 to 2000 liters, preferably 50 to 400 liters, of the ready-to-use spray liquor are applied per hectare of agricultural useful area.

The present invention further relates to a method of controlling phytopathogenic fungi and/or undesired plant growth and/or undesired insect or mite attack and/or for regulating the growth of plants, wherein the agrochemical composition is allowed to act on the respective pests, their environment or the crop plants to be protected from the respective pest, on the soil and/or on undesired plants and/or on the crop plants and/or on their environment.

Examples of suitable crop plants are cereals, for example wheat, rye, barley, triticale, oats or rice; beet, for example sugar or fodder beet; pome fruit, stone fruit and soft fruit, for example apples, pears, plums, peaches, almonds, cherries, strawberries, raspberries, currants or goose-berries; legumes, for example beans, lentils, peas, lucerne or soybeans; oil crops, for example oilseed rape, mustard, olives, sunflowers, coconut, cacao, castor beans, oil palm, peanuts or soybeans; cucurbits, for example pumpkins/squash, cucumbers or melons; fiber crops, for example cotton, flax, hemp or jute; citrus fruit, for example oranges, lemons, grapefruit or tangerines; vegetable plants, for example spinach, lettuce, asparagus, cabbages, carrots, onions, tomatoes, potatoes, pumpkin/squash or capsicums; plants of the laurel family, for example avocados, cinnamon or camphor; energy crops and industrial feedstock crops, for example maize, soybeans, wheat, oilseed rape, sugar cane or oil palm; maize; tobacco; nuts; coffee; tea; bananas; wine (desert grapes and grapes for vinification); hops; grass, for example turf; sweetleaf (Stevia rebaudania); rubber plants and forest plants, for example flowers, shrubs, deciduous trees and coniferous trees, and propagation material, for example seeds, and harvested produce of these plants.

The term crop plants also includes those plants which have been modified by breeding, mutagenesis or recombinant methods, including the biotechnological agricultural products which are on the market or in the process of being developed. Genetically modified plants are plants whose genetic material has been modified in a manner which does not occur under natural conditions by hybridizing, mutations or natural recombination (i.e. recombination of the genetic material). Here, one or more genes will, as a rule, be integrated into the genetic material of the plant in order to improve the plant's properties. Such recombinant modifications also comprise posttranslational modifications of proteins, oligo- or polypeptides, for example by means of glycosylation or binding polymers such as, for example, prenylated, acetylated or farnesylated residues or PEG residues.

The present invention further relates to seed containing the agrochemical composition.

The present invention further relates to a use and a method of application of the hydrophobin for reducing the toxicity (preferably the inhalation toxicology) of the solid water-insoluble pesticide.

The toxicity of the compositions may be tested according to the OECD Guideline for the Testing of Chemicals, No. 403, and the corresponding Guidance Document GD 39, both directed to evaluation of acute inhalation toxicity.

The advantages of the present invention are that the agrochemical composition has a reduced toxicity, especially reduced inhalation toxicity; other advantages are the reduction of tensides used for the composition and its enhanced storage stability.

The examples which follow illustrate the invention without imposing any limitation.

### EXAMPLES

Antifoamer: Silicon defoamer.
Wetting Agent: Polymer of hydroxybenzenesulfonic acid, formaldehyde, phenol and urea.
Ionic Surfactant A: Alkyl naphthalene sulfonate formaldehyde condensate, sodium salt.
Nonionic Surfactant A: Tristyrylphenyl ethoxylate phosphate ester, triethylamine salt, pH (5%, aqueous) 7.5, boiling point greater 100° C.
Bactericide: Aqueous mix of 2-methyl-4-isothiazolin-3-one and 1,2-benzisothiazolin -3-one.
Hydrophobin A: Spray-granulated yaad-Hydrophobin DewA-His₆protein Cloning, fermentation and purification was accomplished according to WO 2006/131564, Examples 1, 2, 7 and 8.

### Example-1

### Preparation of Fluxapyroxad and Chlorothalonil Suspension Concentrate

A Fluxapyroxad and Chlorothalonil suspension concentrate was prepared by mixing water, Adjuvant A, the Ionic Surfactant A, the Wetting Agent, the pesticides, the Hydrophobin A and the Antifoamer. This mixture was wet-milled using a bead mill to a particle size of 2 μm. Propylene glycol, Bactericide, Xanthan Gum and water were added and mixed resulting in a uniform suspension of pH 7.5 to 8.5. The final concentration of the components is given in Table 1.

TABLE 1

| Component | Concentration in g/l |
|---|---|
| Fluxapyroxad | 37.5 |
| Chlorothalonil | 375 |
| Hydrophobin A | 2.2 |
| 1,2-Propylene Glycol | 50 |
| Ionic Surfactant A | 18 |
| Nonionic Surfactant A | 9.0 |
| Xanthan Gum | 3.0 |
| Bactericide | 2.0 |
| Antifoamer | 5.0 |
| Wetting Agent | 5.0 |
| Water | To 1 liter |

### Example-2

### Acute Inhalation Toxicity Evaluation

Two suspension concentrates were prepared according to Example-1, wherein in one of them the admixture of Hydrophobin A was omitted. They were subsequently used for determination of the acute inhalation toxicity by following the OECD Guideline for the Testing of Chemicals, No. 403 (Adopted version from September 7, 2009), and the corresponding Guidance Document GD 39 (Effective date: July 21, 2009). According to Guideline 67/548/EWG (Amended version, effective on Jan. 20, 2009), the results from this study led to a classification of T/T⁺ for the suspension concentrate without Hydrophobin A, whereas the suspension concentrate in admixture with Hydrophobin A was classified as Xn.

Therefore, the addition of Hydrophobin A clearly reduces the toxicity of the agrochemical composition.

1-16. (canceled)

17. A method of preparing an agrochemical composition comprising the steps of
a) preparing a premix by contacting a solid water-insoluble pesticide and a hydrophobin, and
b) preparing a raw suspension by milling the premix;
wherein the water-insoluble pesticide is a polyhalogenated pesticide comprising at least two halogen atoms.

18. The method according to claim 17, where in step a) additionally water is contacted.

19. The method according to claim 17, where in step a) additionally a dispersing agent is contacted.

20. The method according to claim 17, where the pesticide in the raw suspension has an average particle size of below 10 μm.

21. The method according to claim 17, where the premix comprises at least 200 g/l of the pesticide.

22. The method according to claim 17, where the hydrophobin is a polypeptide of the general formula (III)
Xₙ—C¹—X₅₋₉—C²—C³—X₁₁₋₃₉—C⁴—X₂₋₂₃—C⁵—X₅₋₉—C⁶—C⁷—X₆₋₁₈—C⁸—Xₘ (III)
wherein X stands for any of the 20 naturally occuring amino acids (Phe, Leu, Ser, Tyr, Cys, Trp, Pro, His, Gln, Arg, Ile Met, Thr, Asn, Lys, Val, Ala, Asp, Glu, Gly) and wherein the assigned indexes stand for the number of amino acids, wherein the indexes n and m stand for numbers from 0 to 200, C stands for Cystein and at least one of the polypeptide sequences Xm or Xn stands for a peptide sequence of at least 40 amino acids, which is not naturally connected to a hydrophobin, and wherein the hydrophobin causes a shift of the contact angle after coating of a glass surface of at least 20°.

23. The method according to claim 17, where the hydrophobin of formula (III) comprises at least one hydrophobin selected from dewA, rodA, hypA, hypB, sc3, basf1, basf2 or parts or derivatives thereof.

24. The method according to claim 17, where the water-insoluble pesticide is selected from chlorothalonil and fluxapyroxad.

25. An agrochemical composition comprising a solid water-insoluble pesticide and a hydrophobin, where the composition is obtainable by the method as defined in claim 17.

26. The composition according claim 25, wherein the composition comprises from 0.1 g/l to 10 g/l of the hydrophobin.

27. The composition according to claim 25 in form of an aqueous suspension concentrate, which comprises from 30 to 75 wt % of water.

28. The composition according to claim 27, wherein the suspension concentrate comprises at least 100 g/l of the pesticide, from 0.5 g/l to 10 g/l of the hydrophobin, and at least 5 g/l of a dispersing agent.

29. The method of controlling phytopathogenic fungi and/or undesired plant growth and/or undesired insect or mite attack and/or for regulating the growth of plants, wherein the composition of claim 25 is allowed to act on the respective pests, their environment or the crop plants to be protected from the respective pest, on the soil and/or on undesired plants and/or on the crop plants and/or on their environment.

30. Method for reducing the toxicity of a solid water-insoluble pesticide comprising the step of contacting the water-insoluble pesticide with a hydrophobin.

31. Seed treated with the composition of claim 25.

32. The method of claim 29, where the hydrophobin is a polypeptide of the general formula (III)
Xn-C¹-X5-9-C2-C3-X11-39-C4-X2-23-C5-X5-9-C6-C7-X6-18-C8-Xₘ (III)
wherein X stands for any of the 20 naturally occuring amino acids (Phe, Leu, Ser, Tyr, Cys, Trp, Pro, His, Gln, Arg, Ile Met, Thr, Asn, Lys, Val, Ala, Asp, Glu, Gly) and wherein the assigned indexes stand for the number of amino acids, wherein the indexes n and m stand for numbers from 0 to 200, C stands for Cystein and at least one of the polypeptide sequences Xm or Xn stands for a peptide sequence of at least 40 amino acids, which is not naturally connected to a hydrophobin, and wherein the hydrophobin causes a shift of the contact angle after coating of a glass surface of at least 20°.

33. The method of claim 29, where the hydrophobin of formula (III) comprises at least one hydrophobin selected from dewA, rodA, hypA, hypB, sc3, basf1, basf2 or parts or derivatives thereof.
